(19) United States
(12) Patent Application Publication
(10) Pub. No.: US 2024/0330866 A1
(43) Pub. Date: Oct. 3, 2024

(54) VIRTUAL MEETING RECOMMENDATION BASED UPON USER BEHAVIORAL TREND

(71) Applicant: Lenovo (United States) Inc., Morrisville, NC (US)

(72) Inventors: Mark Christopher Heidenfeldt, Apex, NC (US); Mark K. Summerville, Apex, NC (US); Sandy Collins, Durham, NC (US); Justin Ringuette, Cary, NC (US)

(21) Appl. No.: 18/192,030

(22) Filed: Mar. 29, 2023

(51) Int. Cl. G06Q 10/06

(52) U.S. Cl. CPC G06Q 10/109

(57) ABSTRACT

One embodiment provides a method, the method including: identifying, utilizing a behavior system, at least one behavior of a user with respect to a virtual meeting; storing, utilizing the user behavior system, the at least one behavior of the user; determining, utilizing the user behavior system, a behavioral trend of the user with respect to virtual meetings, wherein the behavioral trend is based upon the at least one behavior of the user identified across a plurality of virtual meetings; and generating, utilizing the user behavior system and based upon the behavioral trend of the user, a recommendation for the user for future virtual meetings. Other aspects are claimed and described.

### BACKGROUND

The use of virtual meetings has become a standard business practice. Rather than requiring each attendee of a meeting to be at same location, or on site, virtual meetings provide a method for dynamically attending a meeting from wherever an attendee may be located, as long as a network connection is present. The virtual meetings allow meetings to occur at different times across different geographical locations, thereby allowing for the connection of individuals without having to worry about whether all meeting participants can get together at the same physical location. Virtual meetings are also useful when some participants can be present at the same physical location, but other participants are located at different geographical locations. Since virtual meetings are increasing in use, the features provided by virtual meeting applications have also increased. For example, in virtual meetings different participants can be made the presenter, different participants can talk, cameras and video feeds allow for the viewing of participants within their meeting location environments, presentation features allow for the sharing of screens, applications, and/or other materials, and/or the like, thereby making virtual meetings more closely resemble traditional in-person meetings.

### BRIEF SUMMARY

In summary, one aspect provides a method, the method including: identifying, utilizing a behavior system, at least one behavior of a user with respect to a virtual meeting; storing, utilizing the user behavior system, the at least one behavior of the user; determining, utilizing the user behavior system, a behavioral trend of the user with respect to virtual meetings, wherein the behavioral trend is based upon the at least one behavior of the user identified across a plurality of virtual meetings; and generating, utilizing the user behavior system and based upon the behavioral trend of the user, a recommendation for the user for future virtual meetings.

Another aspect provides an information handling device, the information handling device including: a processor; a memory device that stores instructions that, when executed by the processor, causes the system to: identify, utilizing a user behavior system, at least one behavior of a user with respect to a virtual meeting; store, utilizing the user behavior system, the at least one behavior of the user; determine, utilizing the user behavior system, a behavioral trend of the user with respect to the virtual meetings, wherein the behavioral trend is based upon the at least one behavior of the user identified across the plurality of virtual meetings; and generate, utilizing the user behavior system and based upon the behavioral trend of the user, a recommendation for the user for future virtual meetings.

A further aspect provides a product, the product including: a computer-readable storage device that stores executable code that, when executed by a processor, causes the product to: identify, utilizing a user behavior system, at least one behavior of a user with respect to a virtual meeting; store, utilizing the user behavior system, the at least one behavior of the user; determine, utilizing the user behavior system, a behavioral trend of the user with respect to virtual meetings, wherein the behavioral trend is based upon the at least one behavior of the user identified across a plurality of virtual meetings; and generate, utilizing the user behavior system and based upon the behavioral trend of the user, a recommendation for the user for future virtual meetings.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for generating a recommendation for a user for future virtual meetings by utilizing a user behavior system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Since a virtual meeting is different than the standard in-person meeting, issues specific to an attendee that occur due to the use of technology to access and facilitate the meeting may arise. The misuse of the technology can result in disruptions, tardiness, confusion, and/or the like. For example, it is common practice to mute the microphone of an attendee who is not speaking. However, the muting of the microphone usually has to be performed by the attendee themselves. This can result in an attendee being unaware that they are unmuted during a virtual meeting, which may result in a disruption. Such behavior may be a one-time occurrence or may be repeated by a user over many virtual meetings. When such disruptions routinely occur, particularly by the same attendee, frustration of any other attendee of the virtual meeting may rise.

However, reminders and notifications for virtual meetings have largely remain unchanged from traditional in-person meetings. For example, prior to a scheduled meeting, it is common for an application containing the scheduling information of an attendee to provide a notification to the attendee regarding a start time of a meeting. This may be, for example, 15 minutes prior to the scheduled meeting start time. Such a notification may be supplied for all scheduled events present on a calendar of an attendee, including virtual meetings. In other words, such notifications do not vary based upon the type of meeting that is scheduled.

Some teleconferencing applications utilized to host a virtual meeting may include one or more standard recommendations that are routinely presented when a user signs into the application. For example, when signing into a teleconferencing application and prior to joining a virtual meeting, it is common for the application to provide an attendee with a preview window. In conventional preview windows, options for turning on or off a camera and/or microphone may be present. Then, when an attendee moves forward with accessing the virtual meeting, the camera and microphone options selected in the preview window may be initially set for the attendee while the virtual meeting is ongoing. However, these notifications and setups are standard across all users, meaning the system does not provide notifications or options that are unique to an individual.

Disruptions may occur while a user is attending the virtual meeting. For example, using the issue of an attendee speaking while their microphone is muted, when an attendee is required to speak and/or respond during a virtual meeting and their microphone is muted, a disruption in the virtual meeting may occur. A long pause, and even a loss of a train of thought, could derail a meeting if the fluidity of the meeting is disrupted because of an issue associated with an attendee. In an attempt to combat such disruptions, conventional methods may monitor the status of components (e.g., camera, microphone, etc.), and upon determination that a user is attempting to perform an action that the current status of at least one component does not permit, a notification may be provided to the user. For example, if a microphone of the attendee is muted, and the teleconferencing application monitoring the attendee determines that the attendee is attempting to respond to a question and/or speak during the virtual meeting, the application provide a notification to unmute the microphone to the attendee.

Even though this seemingly proactive attempt to overcome disruption is present, this method is actually reactive, and the amount of time that it requires for a conventional method to recognize an issue and thereafter provide a notification to a user may still cause a disruption in the meeting. Additionally, these reactive methods usually react to determining that a user is doing something that is not currently permitted by a status of a component and is generally directed to audio devices. Therefore, what is needed is a system and method that may identify behaviors of an attendee and generate specific recommendations for the attendee to attempt to negate disruptions caused by the attendee.

Accordingly, the described system and method provides a technique for generating a recommendation for a user for future virtual meetings by utilizing a user behavior system and a determined behavioral trend associated with a user. The user behavior system may identify at least one behavior of a user with respect to a virtual meeting. For example, while a user is attending or participating in a virtual meeting, the system may monitor the user and identify at least one behavior of the user that occurs before, during, or after the virtual meeting. The behavior that is identified may be a behavior that is associated with a disruption or issue or otherwise a behavior of significance with respect to the virtual meeting. An example type of behavior may be the user speaking when a microphone is muted, or conversely, the user speaking or making noise not related to the meeting when the microphone is unmuted. As another example, the system may identify that the user is late for a meeting because the user is consumed in a separate task as a meeting start time is approaching.

The identified at least one behavior of the user may be stored in an accessible storage location. The user behavior system may communicate with at least one accessible storage location that may save all user behaviors. Each user behavior may be stored in a user specific location within a storage device which may include every user behavior identified by the system for a particular user. In other words, each user may have an associated portion of the storage location where identified behaviors of the corresponding user is stored. The user behavior system may determine a behavioral trend of a user with respect to virtual meetings based upon the identified behavior(s) of the user. A behavioral trend may be determined when a least one behavior associated with a user is identified across a plurality of virtual meetings. Alternatively, a behavioral trend may be determined when the behavior is identified within a single meeting. However, whether the behavioral trend is identified based upon multiple occurrences or a single occurrence may be configured within the system.

Based upon a determined behavioral trend, the user behavior system may generate a recommendation for the user for future virtual meetings. In other words, the user behavior system may generate a recommendation to be supplied to the user when the user accesses or attends future virtual meetings, where the recommendation is an attempt by the system to negate a reoccurrence of a user behavior. By reducing or negating the reoccurrence of the user behavior, the system can be utilized to decrease and/or entirely remove disruptions that occur during a virtual meeting. Such a system provides improvements over conventional methods for generating recommendations for a user to reduce disruptions in a virtual meeting by generating recommendations for a user based upon behaviors of that user. In other words, the system provides unique recommendations to users that are based upon behaviors that the user themselves present. Thus, the user behavior system can identify and dynamically determine a behavioral trend of a user, and then provide a specifically generated recommendation for the user to reduce occurrences of a user behavior, thereby resulting in more fluid and disruption-free virtual meetings.

The illustrated example embodiments will be best understood by reference to the figures. The following description is intended only by way of example, and simply illustrates certain example embodiments.

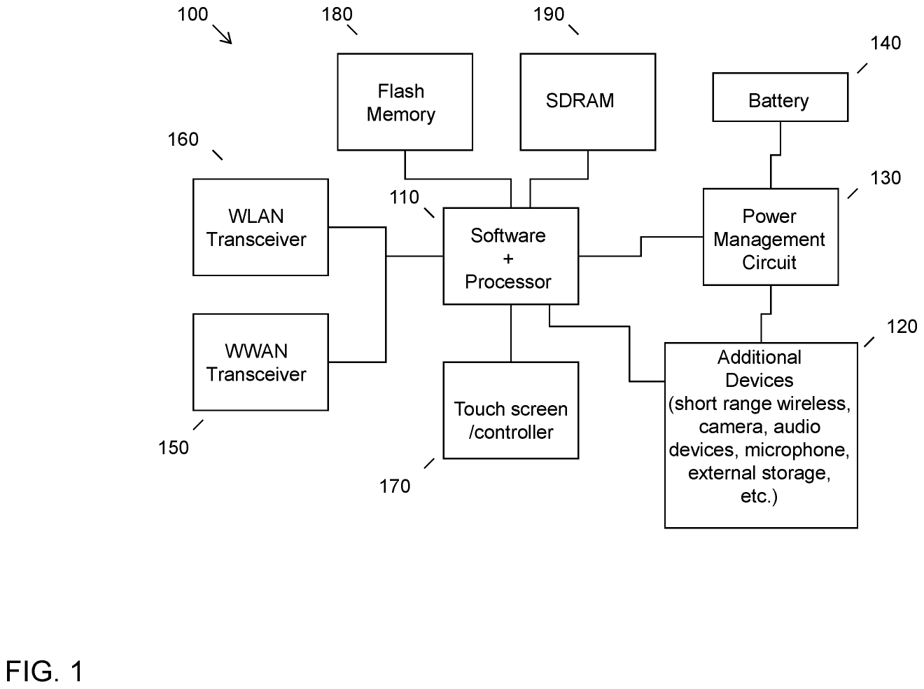

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

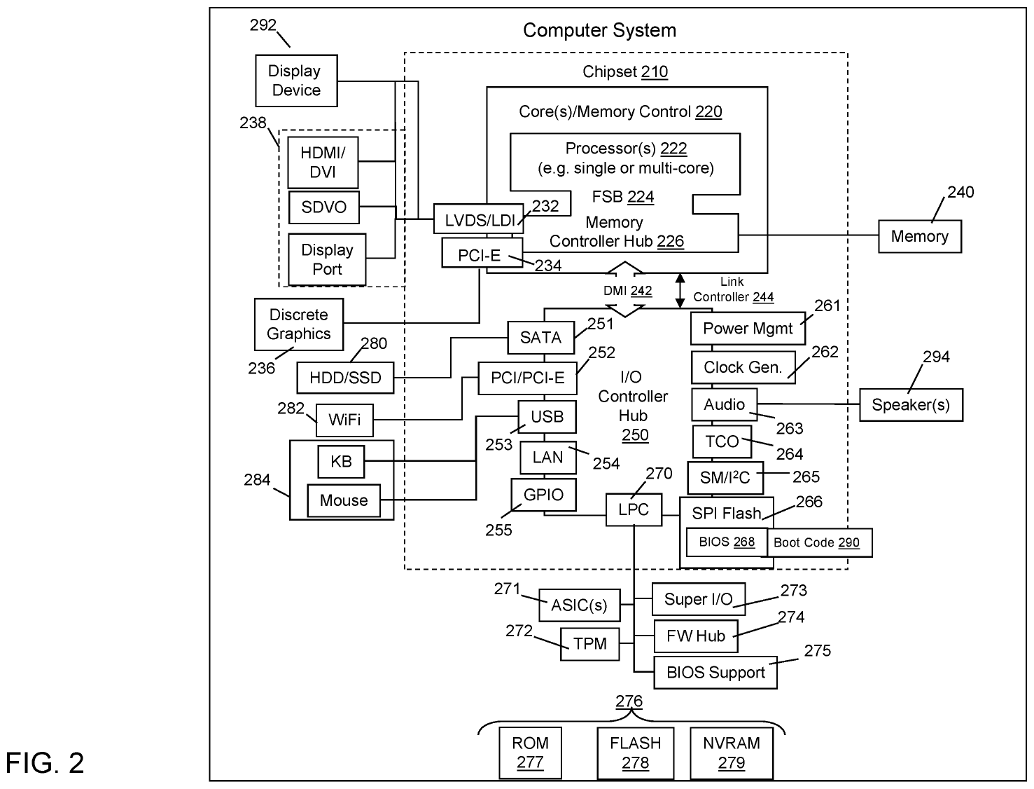

FIG. 2 depicts a block diagram of another example of information handling device circuits, circuitry or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used in a system that identifies and determines a user behavioral trend. The circuitry may also be used in a device or system that monitors the user, identifies behaviors of users, stores user behaviors, generates recommendations for correction of a behavior, and/or the like. For example, the circuitry outlined in FIG. 1 may be implemented in a tablet or smart phone embodiment, whereas the circuitry outlined in FIG. 2 may be implemented in a personal computer embodiment.

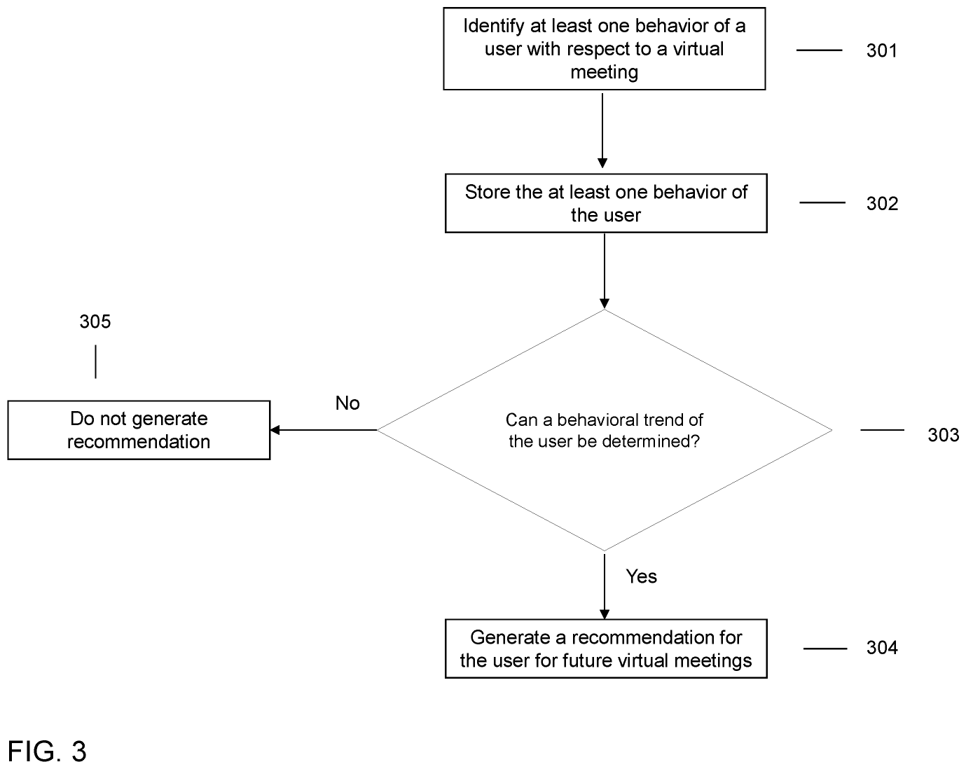

FIG. 3 illustrates an example method for generating a recommendation for a user for future virtual meetings by utilizing a user behavior system. The method may be implemented on a system which includes a processor, memory device, output devices (e.g., display device, etc.), input devices (e.g., keyboard, touch screen, mouse, microphones, sensors, biometric scanners, etc.), and/or other components, for example, those discussed in connection with FIG. 1 and/or FIG. 2. While the system may include known hardware and software components and/or hardware and software components developed in the future, the user behavior system itself is specifically programmed to perform the functions as described herein to generate a recommendation for a user for future virtual meetings using identified behaviors and determined behavioral trends of a user.

The user behavior system may run in the background of an information handling device and may be activated when the device is activated. Additionally, or alternatively, the system may be activated when an application associated with a virtual meeting or other application associated with the user behavior system is activated, detected, or otherwise opened. For example, the user behavior system may not be activated until a virtual meeting application at an information handling device associated with a user is accessed.

Once the user behavior system is activated on a device, the system may be utilized throughout the process of identifying at least one behavior of a user with respect to a virtual meeting, storing the at least one behavior of the user, determining a behavioral trend of the user with respect to virtual meetings based upon the identified at least one user behavior, and generating a recommendation for the user for future virtual meetings. Continued use of the user behavior system identifying behaviors of a user and determining behavioral trends from these behaviors will train the device in producing an accurate behavioral trend, and generating a recommendation for the user based upon the behavioral trend. To perform the steps present in the user behavior system and in order to accurately determine a behavioral trend and generate a recommendation, the user behavior system may utilize a neural network, machine-learning model, and/or other learning algorithm, collectively referred to as a machine-learning model for ease of readability. It should be also noted that multiple machine-learning models may be utilized. The machine-learning model can be trained utilizing previously identified user behaviors, determined behavioral trends, and generated recommendations for the user for future virtual meetings. In other words, the machine-learning model is given access to previously generated recommendations and the user behavior information utilized to determine a user behavioral trend. Additionally, the machine-learning model receives previously successful recommendations for the user for future virtual meetings and adjustments made to settings of a virtual meeting application to further train the machine-learning model. These established recommendations and user behavioral trends are referred to as a training dataset.

Using the training dataset, which may change over time, the machine-learning model learns nuances between user behaviors, behavioral trends, and generated recommendations for future virtual meetings. This results in more accurately identifying a successful recommendation for a behavioral trend-type. For example, the machine-learning model can learn generated recommendations associated with a specific user behavior is the most successful in addressing the user behavior. As information is determined within a generated recommendation from a determined user behavioral trend, the machine-learning model can learn additional nuances and become more accurate and refined over time. Thus, while there is an initial training dataset that is used to initially train the machine-learning model, the machine-learning model is learning over time based upon new information received by the machine-learning model, thereby evolving to become more accurate. This training may be performed automatically by the machine-learning model through automatic ingestion of feedback, which can be generated by or influenced by the model itself, a user, another system, and/or the like.

At 301, a user behavior system may identify at least one behavior of a user with respect to a virtual meeting. In the system, an information handling device being utilized by a user may include or be coupled to at least one sensor to identify at least one behavior of a user. The at least one sensor may include, but is not limited to, a video capturing device (e.g., a camera, infrared image capture device, heat tracking sensor, etc.), an audio capturing device (e.g., a microphone), an activity tracker, an accelerometer, a gyroscope, a proximity sensor, an electromyography sensor, an electroencephalography sensor, and/or the like. The information captured from these sensors may be analyzed by the system to identify a behavior of the user, particularly with respect to a virtual meeting. Thus, the information from the sensors may be combined to identify a behavior, may be analyzed individually to identify a behavior, and/or a combination thereof. The information may also be utilized in raw form to identify a behavior, information may be derived from the sensor information to identify a behavior, and/or a combination thereof.

Identifying the behavior may occur responsive to determining that a user will be attending a virtual meeting. For example, when the system identifies that a virtual meeting will begin in fifteen minutes, the user behavior system may monitor a user, using one or more sensors, until completion of or shortly after the virtual meeting. As the system is monitoring the user, the system may attempt to identify any behaviors of the user. While any behaviors of the user may be identified, the system may specifically be attempting to identify any user behaviors that may be negatively affecting the virtual meeting. In other words, the system may attempt to identify behaviors of the user that are causing a disruption to the virtual meeting, causing frustration to other attendees of the virtual meeting, or other behaviors negatively affecting the flow or conduction of the virtual meeting or the experience of other attendees of the virtual meeting.

Behaviors that may be identified with respect virtual meeting may be any action and/or inaction that a user performs either prior to, during, or shortly after a virtual meeting that has some effect or bearing on the virtual meeting. For example, if the user is eating before the meeting but does not eat during the meeting, the system may ignore such behavior because it does not have an effect on the virtual meeting. On other hand, if the user is eating before the meeting and continues to eat during the meeting, the system may identify the behavior if it has an effect on the meeting. Thus, identifying at least one behavior of the user may include identifying a behavior of a user that may negatively impact a user, either the monitored user or other users or attendees of the meeting, during a virtual meeting. Behaviors that may negatively impact the monitored user may be behaviors that negatively influence a user's understanding of the information being provided during the virtual meeting. For example, a behavior that may negatively influence a user's understanding of the information may be joining a virtual meeting late, failure to activate a camera while a virtual meeting is ongoing, failure to obtain/utilize a peripheral device, failure to disable a microphone when the monitored user is not talking to the other attendees, and/or the like.

Additionally, or alternatively, identifying at least one behavior of the user, at 301, may include identifying a behavior of a user that may negatively influence or impact the virtual meeting. Behaviors that may negatively influence the virtual meeting may be a behavior of a user that disrupts the fluidity of the virtual meeting or negatively affects attendees, therefore influencing the understanding of the information in the virtual meeting for all attendees. For example, a behavior that may negatively influence the virtual meeting may include a hot microphone that may capture unintended audio from a user, failure to activate a microphone when speaking causing a pause in conversation, failure to activate a camera when instructed, activating a camera when the user is in motion, and the like.

To identify the behavior of the user, the system may monitor (e.g., utilizing the one or more sensors, using one more sensors of other devices, monitoring a video feed of the virtual meeting, etc.) actions, noises, reactions, facial features, and/or the like, of the monitored user and/or other meeting attendees. These will collectively be referred to as actions for ease of readability. The system can analyze these monitored actions to classify the actions and identify a sentiment of the monitored user or other attendees. Actions that convey negative sentiments (e.g., annoyance, frustration, disgust, impatience, confusion, etc.), may indicate that a behavior of the monitored user has negatively affected the virtual meeting. The system may also compare actions or behaviors of the user to known actions or behaviors that have been identified as negatively impacting virtual meetings. These actions or behaviors that have been identified or are known as negatively impacting virtual meetings can be identified from historical data, stored annotated data, crowd-sourced data, machine-learning models, and/or the like.

Once the at least one behavior is identified for a user, the system may store the identified behavior of the user in an appropriate storage device or location at 302. Storing the at least one user behavior includes using a storage device or location operatively coupled to or accessible to the system. Since the system may store behaviors that are assigned to users, the storage device may be a local storage device or location of the user. Additionally, or alternatively, the storage device or location may be a remote storage device or location, cloud storage device or location, network storage device or location, storage device or location of the user behavior system, and/or the like. In other words, the storage device may be any type of storage device or location that can work in combination and be accessed by the user behavior system.

The storage of the at least one behavior of the user may include storing the at least one behavior of the user in a user profile. A user profile may permit the storing and associating of an identified behavior with additional user behaviors of a particular individual. A user profile may contain a plurality of identified behaviors performed by a user over time. The stored behaviors of the user may be sorted or grouped by behavior. In other words, the system may store occurrences of the same behavior and/or behaviors closely related to one another within a single group. For example, the system may store a user behavior associated with joining a virtual meeting 30-seconds late, or after the start of the virtual meeting, with a previous occurrence of the user joining a virtual meeting two-minutes late. Thus, the user profile may include groups of user behaviors, individual user behaviors, and/or the like. The user profile may also include other information, for example, time of occurrence, frequency of occurrence, virtual meetings and/or attendees affected by the behavior, and/or any other information. Thus, the user profile allows the system to reference a collection of user behaviors in a singular location. However, it should be noted that the use of a user profile is not strictly necessary and other techniques for storing and assigning or otherwise annotating behaviors with users is possible and contemplated.

At 303, the system may then determine if a behavioral trend of the user can be determined based upon the identified at least one behavior of the user. This determination may take into account any behaviors that have been stored in association with the user. Determining a behavioral trend, at 303, may be based upon determining the at least one behavior of the user is identified across a plurality of virtual meetings. Subsequent to storing at least one behavior of the user, the user behavior system may identify from each user behavior saved, whether a behavior of a user has become a common occurrence, or has been performed multiple times, by the user. When determining a behavioral trend, the user behavior system may identify at least one behavior exceeds a predetermined threshold of occurrences. Behavioral trends may also be identified based upon a single occurrence of a behavior. Egregious behaviors, or behaviors that are particularly disruptive to a virtual meeting, may be labeled as a behavioral trend even if only a single occurrence has been identified.

From the stored occurrences of behavior, the system may determine, at 303, a threshold level of occurrences that may establish a need of a reminder, or a recommendation, to be provided back to the user in an attempt to negate another occurrence of the user behavior. The threshold level of occurrences may be a predetermined number of occurrences, and may vary based upon the behavior. Thus, for one behavior the predetermined number of occurrences may be one and for another behavior, the predetermined number of occurrences may be higher, for example, twenty. Additionally, different virtual meetings may have different threshold values. In other words, based upon different attributes of the virtual meetings, the system may store different threshold values. As an example, a particular meeting organizer may have a set threshold value, while a different organizer may have different threshold values. Other attributes of meetings may include, but are not limited to, a number of participants, participants of the meeting, a type of meeting, a topic of the meeting, and/or the like. Based upon determining that a threshold level of occurrences for a behavior has been met or exceeded, the system determines a behavioral trend of the user exists at 303. In the system, the predetermined threshold level of occurrences may be set by a manufacturer of the system, an employer, an overarching entity, the user, organizers of virtual meetings, and/or the like.

A frequency or number of behaviors in determining a behavioral trend may be based upon a frequency or number within a single virtual meeting, a frequency or number of the behaviors across meetings, and/or the like. In other words, the system may identify an occurrence of a behavior based upon an amount of times a behavior is performed, and may identify an amount of virtual meetings that a user has performed a behavior within. Thus, when determining if at least one behavior of the user is associated with a behavioral trend of the user, at 303, the user behavior system may identify an occurrence of a user behavior across a plurality of virtual meetings, and may also identify an amount of occurrences present during a single virtual meeting. This information may be used to weight the occurrences across the plurality of virtual meetings. For example, if the system identifies that the behavior has occurred across five meetings, but only a single time in each meeting it may not be identified as a behavioral trend. However, if the system identifies that the behavior has occurred across five meetings and also three times within each meeting, the behavior may be identified as a behavioral trend. The criteria for identifying a behavior as a behavioral trend can be configured by a user, entity, and/or the like.

If the system determines that a behavioral trend cannot be determined at 303, the system may not generate a recommendation at 305. This may occur if the number or correlation of behavior occurrences is below the threshold value. In other words, if the user behavior system determines that the behavior does not constitute a behavioral trend that would necessitate a recommendation, the system may not provide a recommendation at 305.

On the other hand, if the system determines a behavioral trend is present at 303, the system may determine a recommendation is required. Thus, the system may then generate a recommendation for the user for future virtual meetings at 304. Generating a recommendation for the user includes providing a notification to a user identifying the behavior of the user present in the determined behavioral trend and a recommendation or notification that attempts to prevent performance of the user behavior associated with the behavioral trend. In other words, generating a recommendation for a user attempts to overcome a identified behavior of the user. Information contained within the recommendation can vary. For example, the user behavior may not be specifically identified in the recommendation. A recommendation may be provided for each behavior being addressed. For example, when it is determined that a user behavioral trend is present for a single behavior, a recommendation addressing the single may be provided. Additionally, or alternatively, in the system, when it is determined that a behavioral trend for two or more separate behaviors is present, a corresponding number of recommendations may be provided for each determined behavioral trend. However, this is not strictly necessary as a single recommendation may be utilized to address multiple behaviors.

Generating a recommendation for the user for future virtual meetings, at 304, may prompt a user to perform an action to address the at least one behavior before attending a future virtual meeting. The recommendation may include instructions directing a user to adjust one or more virtual meeting components in order to address the at least one behavior for the upcoming, virtual meeting. For example, if a user behavioral trend associated with a user failing to turn-on a camera prior to a virtual meeting is identified, the user behavior system may provide a notification including instructions or a recommendation to activate a camera prior to joining a virtual meeting. Generating a recommendation to be supplied to the user in a notification form may also include a prompt for potentially adjusting user settings. The prompt for adjusting user settings may be a portion of the notification provided, or may be an additional notification provided alongside the recommendation. Continuing the previous example, when a behavioral trend of a user describes a failure to activate a camera prior to joining a virtual meeting, a recommendation to activate a camera is presented to the user. Additionally, an option to adjust user preference settings, for example, an option to change the default setting from an initially inactive camera to an initially active camera, may be provided.

The recommendation may have different attributes and different behavioral trends may result in different recommendations. Attributes of a recommendation include a recommendation type (e.g., pop-up, banner, window, integrated into an application window, notification, etc.), recommendation size, recommendation content (e.g., instructions, reminders, setting change options, etc.), recommendation frequency (e.g., every time the user performs a particular motion, every time the user accesses an application, when a meeting reminder is provided, at particular time intervals, etc.), recommendation duration (e.g., length of the meeting, until the user addresses the recommendation, until the user modifies a setting, a set length of time, etc.), and/or the like.

For example, the recommendation may include a banner notification that remains present for the duration of a virtual meeting. A banner notification may contain a reminder of the recommendation to address the at least one behavior and could be located along the edge of a window corresponding to the virtual meeting application. As a non-limiting example, a banner notification may be present along the top edge of a display window corresponding to the virtual meeting application, and may contain a reminder to perform, or not perform, an action to address an identified user behavior. For example, if a user routinely forgets to unmute themselves prior to speaking, the banner notification may include the language, “UNMUTE MICROPHONE BEFORE SPEAKING.” It should be noted that the system may provide multiple recommendations to address the same user behavior. Using the banner notification example, the system may also provide a recommendation to the user when the user first activates the virtual meeting application to unmute the microphone before speaking.

The user behavior system may also monitor when a user is implementing the recommendations provided. This monitoring may be similar to the monitoring that was utilized to identify at least one behavior of the user. Thus, the system may use at least one sensor to determine if the user is implementing the actions, or inactions, identified in the provided recommendation. When the system determines that the user is not implementing the recommendation generated, the user behavior system may then generate a different recommendation for the user based upon this updated user behavior, and therefore, updated behavioral trend. For example, if a user is reminded to activate the camera in a recommendation previously provided prior to a virtual meeting and fails to do so, the user behavior system may provide a dynamic and different recommendation in an attempt to address this issue. For example, the system may continue to provide the previous recommendation and may also add a recommendation in the form of a banner notification for the duration of the virtual meeting. As another example, the system may provide multiple recommendations at different times before and/or during the virtual meeting. The user behavior system may continue to dynamically change the recommendation and/or recommendation attributes until the user addresses the behavior.

The type of recommendation that is provided, when the recommendation is provided, the content included within the recommendation, a frequency of provision of the recommendation, and/or the like, may be based upon not only the behavioral trend that is being addressed, but also based upon an identification of recommendations and recommendation attributes that are useful for actually addressing the behavior. In this case, the system may utilize one or more learning techniques, for example, a machine-learning model, analysis of historical data, access to and analysis of crowd-sourced data, and/or the like, to make the identification of the recommendations and recommendation attributes (e.g., frequency of recommendation, time of recommendation provision, content of recommendation, type of recommendation, etc.). This allows behaviors and reactions of the user to influence the recommendation and recommendation attributes. In other words, not only are the recommendation and recommendation attributes based upon the behavior and behavioral trend, but they are also dynamically chosen based upon the user and reactions of the user that provide an indication regarding recommendation and recommendation attributes that are actually useful for the user.

When it is determined by the user behavior system that a user is addressing the behavior based upon a recommendation provided, the system may thereafter withhold a recommendation corresponding to the user behavior. As the user behavior system is monitoring a user's behaviors prior to and during a virtual meeting, one or more actions or reactions associated with a recommendation may be implemented by a user and recorded by the user behavior system. This monitoring may be performed in a similar manner as previously discussed monitoring. To determine that the user has successfully addressed the user behavior, the user behavior system may determine that the user has implemented a recommendation a threshold number of times. Thus, the system may keep track of the number of times a recommendation was implemented and only remove or without the recommendation once the threshold has been reached or exceeded. This threshold may vary based upon the behavior related to the recommendation. Thus, as a user behavior becomes less common, the need for a recommendation for combatting the user behavior may be less necessary, and potentially, completely removed.

The various systems herein thus describe a technical improvement over conventional methods for generating recommendations regarding virtual meetings for a user. Rather than relying on reactive methods that may still result in the user negatively affecting the virtual meeting, and potentially influencing a level of understanding of the information present in a virtual meeting, the system and method herein provides a method for dynamically providing a recommendation to the user, in an attempt to address the user behavior. Further, the system has the ability to dynamically adjust recommendations and recommendation attributes based upon action or inaction of the use in response to a recommendation. The user behavior system's ability to identify at least one behavior of a user, store this user behavior information, and then determine from the stored information if a user behavioral trend is present, provides the system with an ability to proactively recommend correction to a user behavior without interrupting an ongoing virtual meeting.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
identifying, utilizing a behavior system, at least one behavior of a user with respect to a virtual meeting;
storing, utilizing the user behavior system, the at least one behavior of the user;
determining, utilizing the user behavior system, a behavioral trend of the user with respect to virtual meetings, wherein the behavioral trend is based upon the at least one behavior of the user identified across a plurality of virtual meetings; and
generating, utilizing the user behavior system and based upon the behavioral trend of the user, a recommendation for the user for future virtual meetings.

2. The method of claim 1, wherein the recommendation addresses the at least one behavior of the user.

3. The method of claim 1, wherein the storing comprises associating the at least one behavior of the user with the user in a user profile.

4. The method of claim 1, wherein the determining a behavioral trend comprises identifying the at least one behavior exceeds a predetermined threshold of occurrences.

5. The method of claim 1, wherein the generating comprises providing a notification to the user.

6. The method of claim 5, wherein the notification comprises prompting the user to perform an action to address the at least one behavior before attending one of the future virtual meetings.

7. The method of claim 5, wherein the notification comprises a banner notification provided to the user while one of the future virtual meetings, wherein the banner notification comprises a reminder of the recommendation to address the at least one behavior.

8. The method of claim 1, wherein the generating comprises generating a different recommendation for the user based upon the behavioral trend of the user and responsive to identifying the recommendation did not result in the user addressing the at least one behavior for one of the future virtual meetings.

9. The method of claim 1, further comprising:
determining the user performed a modification to a setting of a virtual meeting related to the at least one behavior prior; and
withholding the recommendation.

10. The method of claim 1, wherein the recommendation is unique to the user and is generated utilizing a machine-learning model.

11. An information handling device, the information handling device comprising:
a processor;
a memory device that stores instructions that when executed by the processor, causes the information handling device to:
identify, utilizing a user behavior system, at least one behavior of a user with respect to a virtual meeting;
store, utilizing the user behavior system, the at least one behavior of the user;
determine, utilizing the user behavior system, a behavioral trend of the user with respect to the virtual meetings, wherein the behavioral trend is based upon the at least one behavior of the user identified across the plurality of virtual meetings; and
generate, utilizing the user behavior system and based upon the behavioral trend of the user, a recommendation for the user for future virtual meetings.

12. The information handling device of claim 11, wherein the recommendation addresses at least one behavior of the user.

13. The information handling device of claim 11, wherein the storing comprises associating the at least one behavior of the user with the user in a user profile.

14. The information handling device of claim 11, wherein the determining a behavioral trend comprises identifying the at least one behavior exceeds a predetermined threshold of occurrences.

15. The information handling device of claim 11, wherein the generating comprises providing a notification to the user.

16. The information handling device of claim 15, wherein the notification comprises prompting the user to perform an action to address the at least one behavior before attending on the future virtual meetings.

17. The information handling device of claim 15, wherein the notification comprise a banner notification provided to the user while one of the future virtual meetings, wherein the banner notification comprises a reminder of the recommendation to address the at least one behavior.

18. The information handling device of claim 11, wherein the generating comprises generating a different recommendation for the user based upon the behavioral trend of the user and responsive to identifying the recommendation did not result in the user addressing the at least one behavior for one of the future virtual meetings.

19. The information handling device of claim 11, further comprising:
determining the user performed a modification to a setting of a virtual meeting related to the at least one behavior prior; and
withholding the recommendation.

20. A product, the product comprising:
a computer-readable storage device the stores executable code that, when executed by the processor, causes the product to:
identify, utilizing a user behavior system, at least one behavior of a user with respect to a virtual meeting;
store, utilizing the user behavior system, the at least one behavior of the user;
determine, utilizing the user behavior system, a behavioral trend of the user with respect to virtual meetings, wherein the behavioral trend is based upon the at least one behavior of the user identified across a plurality of virtual meetings; and
generate, utilizing the user behavior system and based upon the behavioral trend of the user, a recommendation for the user for future virtual meetings.
